(19) United States
(12) Patent Application Publication
(10) Pub. No.: US 2006/0242038 A1
(43) Pub. Date: Oct. 26, 2006

(54) Method for charging costs of enjoying contents transmitted over a telecommunications network, preferably by the internet network, and related system

(76) Inventor: Michele Giudilli, Mattinata ( Foggia) (IT)

Correspondence Address: SUGHRUE MION, PLLC, 2100 PENNSYLVANIA AVENUE, N.W., SUITE 800, WASHINGTON, DC, 20037, US

(21) Appl. No.: 10/564,641

(22) PCT Filed: Jul. 12, 2004
(86) PCT No.: PCT/IT04/00386

§ 371 Date: Apr. 19, 2006

(30) Foreign Application Priority Data
Jul. 14, 2003 (IT) RM2003A000341

(51) Int. Cl. G07F 19/00; G06Q 40/00; G07B 17/00

(52) U.S. Cl. 705/35; 705/30

(57) ABSTRACT

The invention concerns a method for charging costs of enjoying contents transmitted over a telecommunications network, preferably the Internet network, wherein chargeable contents, in the shape of one or more digital documents or files, are transmitted from at least one server (3) of a Contents Provider (or CP), which a user accesses by means of a computer (4) connected to said at least one server (3) through the telecommunications network, a gateway system (2, 5, 7) carrying out the checks for authorization of the user's access to the chargeable contents, an electronic wallet (5) performing operations of charging costs to a user's account, the method being characterized in that it preliminary associates one or more additional information related to file charging criteria with each chargeable file, and in that it comprises the following steps: A. at each transmission of at least one portion of a chargeable file from said at least one server (3) of the CP to the user's computer (4), reading and interpreting said additional information associated with the file; B. transmitting to the user's computer (4) said at least one portion of the chargeable file, and C. transmitting to the electronic wallet (5) data related to charging as a function of said additional information associated with the file. The invention further concerns the related system and the related instruments and apparatuses performing the method.

The present invention refers to a method for charging costs of enjoying contents transmitted over a telecommunications network, preferably the Internet network, that allows charging only data effectively transmitted to users in a simple, reliable, sturdy, and safe way, complying with privacy of users.

The present invention further refers to the related system and to the related instruments and apparatuses necessary for performing the method.

More in particular, the present invention refers to a hardware/software platform performing the method proposed by the inventor for distributed management of a payment system for enjoying contents of any kind, as texts, audio ones, and video ones, over a telecommunications network such as the Internet network.

Presently, providers of textual, audio, video, or software information and contents (i.e. of any digital product or service hereinbelow indicated as “contents”) operate on the Internet network through web sites providing for chargeable enjoyment of such services by using forms of subscription, on a monthly basis or through a form of payment for temporary use of the contents by means of pre-paid accounts.

A conventional electronic transaction is based on a certain content, which is delivered only after the payment has occurred, either as a single one or a subscription one. Mode is wholly similar to transactions having material goods as subject matter, i.e. once the payment has been made by the client or user, shipment of acquired goods is carried out.

These systems suffer from some drawbacks due to the fact that they are not much flexible nor proper for contents user and providers.

In fact, subscription is not implementable for contents enjoyment along a limited period (as for example in case of single consultation, or of consultations along few days), since contents providers require enabling subscription periods longer than that of effective enjoyment (for example it is usually required a monthly or yearly subscription).

Moreover, opening a dedicated account with each single provider is financially disadvantageous for the user, since he/she is compelled to subscribe several subscriptions with the various information providers which he/she wants to access.

Furthermore, enabling each subscription requires advance payment through on line procedure with on line payment by means of credit card, or with other electronic or traditional systems, which is not much suitable for payments of the order of cents or of residual amount.

Still, price required by contents providers on yearly or monthly basis sometimes results excessively expensive for the user who is compelled to pay for a service that he/she then uses for a very small part.

Moreover, the present system of on line payments (by means of credit card or other electronic payment system) is not much adapted for payment of small amounts as it may be the cost of a single consultation or access to an audio/video source, because of the high costs a single transaction operating on interbank circuits, and also because of the risks connected to using credit cards on the Internet network.

Presently, just because of lack of a practical system of payment for contents, on line contents providers, also known as “contents provider” or “CP”, have as main profit source the sale of advertising spaces, which is not always capable to refund the service costs.

It is therefore an object of the present invention to solve this series of drawbacks and to remove obstacles which presently prevent a contents payment model from taking off, through a method for charging costs of enjoying contents transmitted over a telecommunications network, preferably the Internet network, that allows charging only data effectively transmitted to users in a simple, reliable, sturdy, and safe way, complying with privacy of users and ensuring safety of the payment system and of the delivery of chargeable contents.

It is a further object of the present invention to provide the instruments, the apparatuses, and the system performing the method.

Such objects are reached through a platform independent from the CP, the user and the possible financial institution, which arranges for checking the user identity, measuring the contents effectively transmitted from the CP to the user, and charging the user account for costs thereof.

It is specific subject matter of the present invention a method for charging costs of enjoying contents transmitted over a telecommunications network, preferably the Internet network, wherein chargeable contents, in the shape of one or more digital documents or files, are transmitted from at least one server of a Contents Provider (or CP), which a user accesses by means of a computer connected to said at least one server through the telecommunications network, a gateway system carrying out the checks for authorisation of the users access to the chargeable contents, an electronic wallet performing operations of charging costs to a user's account, the method being characterised in that it preliminary associates one or more additional information related to file charging criteria with each chargeable file, and in that it comprises the following steps:

A. at each transmission of at least one portion of a chargeable file from said at least one server of the CP to the user's computer, reading and interpreting said additional information associated with the file;

B. transmitting to the user's computer said at least one portion of the chargeable file; and

C. transmitting to the electronic wallet data related to charging as a function of said additional information associated with the file.

Always according to the invention, the electronic wallet may be integrated into the gateway system.

Still according to the invention, the electronic wallet may be integrated into the user's computer.

Preferably according to the invention, at least one part of steps A, B, and C is performed by a routing electronic apparatus or application router, that will be hereinbelow called as “Value Added Router” or “VA router”.

Always according to the invention, said additional information associated with each chargeable file may comprise:

a file type, preferably according to MIME encoding, and/or

a charging mode preferably selected from the group comprising start charge, end charge, and charge during streaming, and/or

a tariff unit, preferably selected from the group comprising packet unit, document unit, flat rate unit, and/or

a tariff unit cost, and/or

a tariff unit interval for charging, and/or

a user's identification code, and/or

a CP identification code, and/or

a file title or identifier.

Still according to the invention, said at least one chargeable file portion transmitted in step A may be included in a data packet.

Furthermore according to the invention, said additional information associated with each chargeable file may be directly encoded in the chargeable file and/or are included in an auxiliary file associated with the chargeable file. Said additional information associated with the chargeable file, in one of the modes identified above, form a specific protocol that is read and interpreted by the VA router. In the following, such protocol will be called as “VAP” or “Value Added Protocol” protocol.

Always according to the invention, said at least one chargeable file portion and said associated additional information may be encoded in a transmission protocol.

Still according to the invention, said at least one chargeable file portion transmitted in step A may be included in a data packet encoded in the VAP protocol.

Always according to the invention, step C may be performed immediately before start of transmission of step B or immediately after the end of transmission of step B or periodically during transmission of step B.

Still according to the invention, the method may further comprise the following step:

D. at each transmission of at least one chargeable file portion from said at least one CP server to the user's computer, reading and/or recording data related to charging as a function of said additional information associated with the file.

Furthermore according to the invention, step C may be periodically performed independently from time periods of transmission of step B.

Always according to the invention, step D may be performed by the router.

Still according to the invention, the gateway system may comprise a first gateway apparatus.

Furthermore according to the invention, the gateway system may be distributed and may comprise at least a second gateway apparatus connected to the first gateway apparatus.

Always according to the invention, the gateway system may operate according to the mechanism of clearing houses used in financial environment.

Still according to the invention, the gateway system and/or the router may operate as escrow between the server and the user accessing by means of the computer. In the method according to the invention and in the related system, the router by itself or in combination with the gateway may operate according to the mechanism of the escrow service, i.e. as fiduciary service independent from the user and the server, checking that chargeable content transmission reaches the user and that only what effectively transmitted is charged, owing to the fact that it performs step D.

Still according to the invention, in step B information related to cost and/or to the status of chargeable file transmission may be transmitted to the user's computer.

Always according to the invention, the user may be apt to access two or more servers by means of the computer by inputting data registered in the gateway system which define a sole user's digital identity recognised as valid for all said two or more servers. In particular, the user may use a sole username and a sole password, i.e. a sole identity, previously registered with a gateway, operating as a sign-one system where the user may access two or more sites, which implement the daemon software operating on the server, by using a sole digital identity. In other words, the user may access two or more servers, on which the daemon software operates, through a unique authentication valid for all the sites. Such goal is possible owing to the fact that the router keeps records of the user's session and automatically authenticates the user for the second server.

Still according to the invention, the router may read and interpret a user's digital identity for locating, through a gateway search system (using at least one DNS—Domain Name System—function), an IP address of the gateway system corresponding to the user's one, the router forwarding to the gateway system the authentication request and carrying out charging of contents uses enjoyed by the user accessing by means of the computer. In particular, the router may implement a gateway search system that reads and interprets the user's identity, by using the domain name of the user's username (preferably in the shape of username@gatewaydomain, where gatewaydomain is the domain name of the gateway with which the user is registered), for locating the IP address of the gateway corresponding to the one of the user, through a query to a DNS system. The router will use the gateway so located among multiple gateways, forwarding the authentication request to it and carrying out charging of contents uses enjoyed by the user.

It is still subject matter of the present invention a for charging costs of enjoying contents transmitted over a telecommunications network, preferably the Internet network, comprising at least one server of a Contents Provider (or CP), apt to transmit chargeable contents, in the shape of one or more digital documents or files encoded in the VAP protocol, one or more computers, by means of which one or more users access said at least one server, a gateway system, apt to carry out checks of authorisation of user's access to the chargeable contents and operations of charging costs to a user's account, the system being characterised in that it performs the previously described method for charging costs of enjoying contents transmitted over a telecommunications network.

Preferably according to the invention, said at least one server is provided with a plug-in or daemon software, interfacing the http server program that associates said additional information related to file charging criteria with each chargeable file.

Always according to the invention; said at least one server may perform steps A, B, and C of the previously described method for charging costs of enjoying contents transmitted over a telecommunications network.

Preferably according to the invention, the system further comprises a routing electronic apparatus or router (the VA router), comprising a processing unit, one or more memory units, one or more input/output interfaces, apt to connect to said at least one server, to the gateway system, and to said one or more computers, and apt to perform steps A, B, and C of the previously described method for charging costs of enjoying contents transmitted over a telecommunications network.

It is further subject matter of the present invention a routing electronic apparatus or VA router, comprising a processing unit, one or more memory units, one or more input/output interfaces, characterised in that it is apt to be used in a system for charging costs of enjoying contents transmitted over a telecommunications network as previously illustrated, wherein the VA router is apt to connect to said at least one server, to the gateway system, and to said one or more computers, and it is apt to perform steps A, B, and C of the previously described method for charging costs of enjoying contents transmitted over a telecommunications network.

It is still subject matter of the present invention an electronic document or file, preferably encoded in the VAP protocol, apt to be transmitted by at least one server of a Contents Provider (or CP) in exchange of a payment according to the previously described method for charging costs of enjoying contents transmitted over a telecommunications network, and in that it is provided with said additional information associated with it.

It is another subject matter of the present invention a computer program characterised in that it comprises code means adapted to execute, when running on at least one computer, steps A, B, and C of the previously described method for charging costs of enjoying contents transmitted over a telecommunications network.

It is further subject matter of the present invention a memory medium, readable by a computer, storing a program, characterised in that the program is the just described computer program.

It is also subject matter of the present invention a computer program characterised in that it comprises code means adapted to execute, when running on a router, step A of the previously described method for charging costs of enjoying contents transmitted over a telecommunications network.

It is further subject matter of the present invention a memory medium, readable by a computer, storing a program, characterised in that the program is the just described computer program.

It is still subject matter of the present invention a computer program characterised in that it comprises code means adapted to execute, when running on at least one server of a Contents Provider (or CP) apt to transmit one or more chargeable file, the operation of association of one or more additional information related to file charging criteria with each chargeable file. Said program may further include functions allowing said server administrator, by way of example, to:

a) configure the IP address of the main VAR and a backup secondary one; and

b) set charging modes, financial remunerations, contents depending on the contents type, time and criteria for access.

It is further subject matter of the present invention a memory medium, readable by a computer, storing a program, characterised in that the program is the just described computer program.

It is also subject matter of the present invention a computer program characterised in that it comprises code means adapted, when running on at least one computer, to interface to the http server of the server and to re-address the authentication requests of at least one user and the data flow towards the router of which it has stores the IP address.

It is still subject matter of the present invention a memory medium, readable by a computer, storing a program, characterised in that the program is the just described computer program.

The present invention will be now described, by way of illustration and not by way of limitation, according to its preferred embodiments, by particularly referring to the Figures of the enclosed drawings, in which:

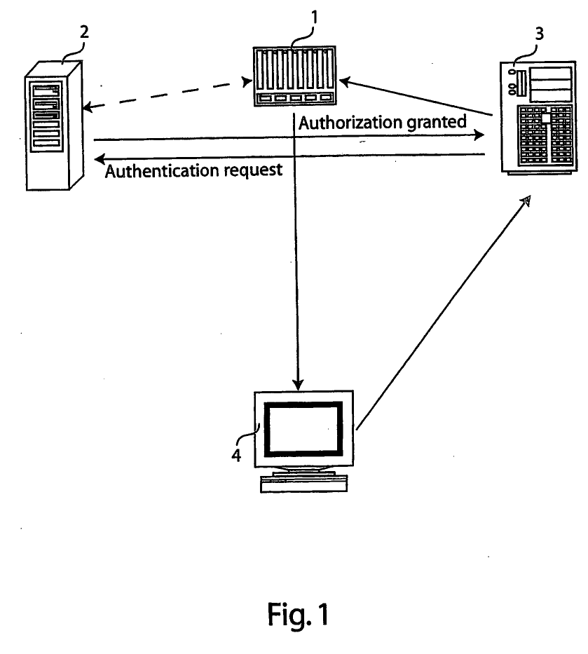

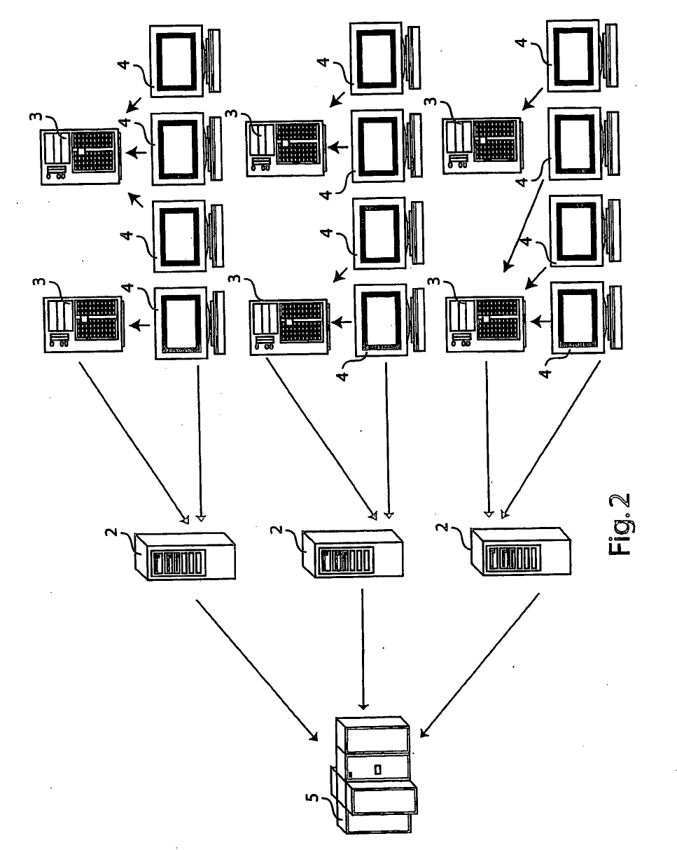

FIG. 1 shows a schematic diagram of a first embodiment of the method according to the invention;

FIG. 2 shows a first schematic diagram of a second embodiment of the system according to the invention;

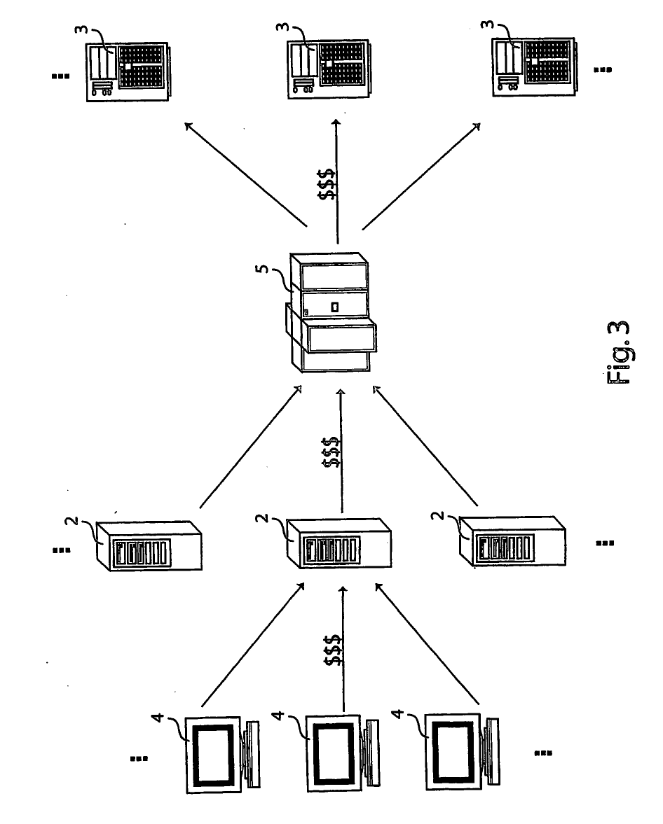

FIG. 3 shows a second schematic diagram of the system of FIG. 2;

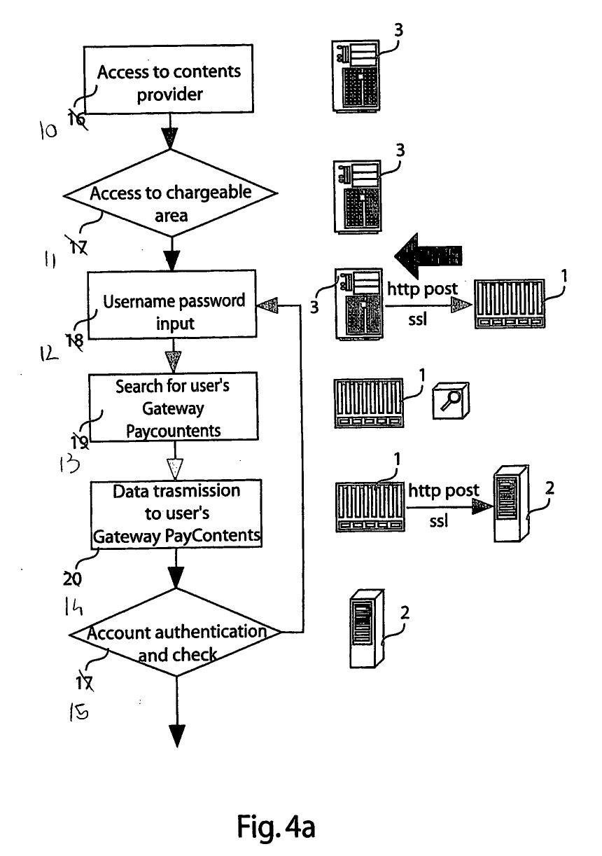

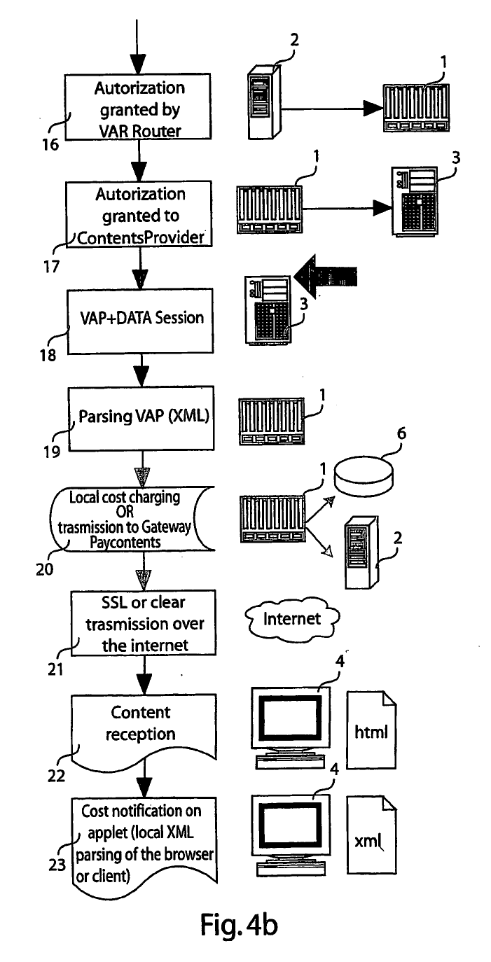

FIGS. 4a and 4b show a flow diagram of a third embodiment of the method according to the invention;

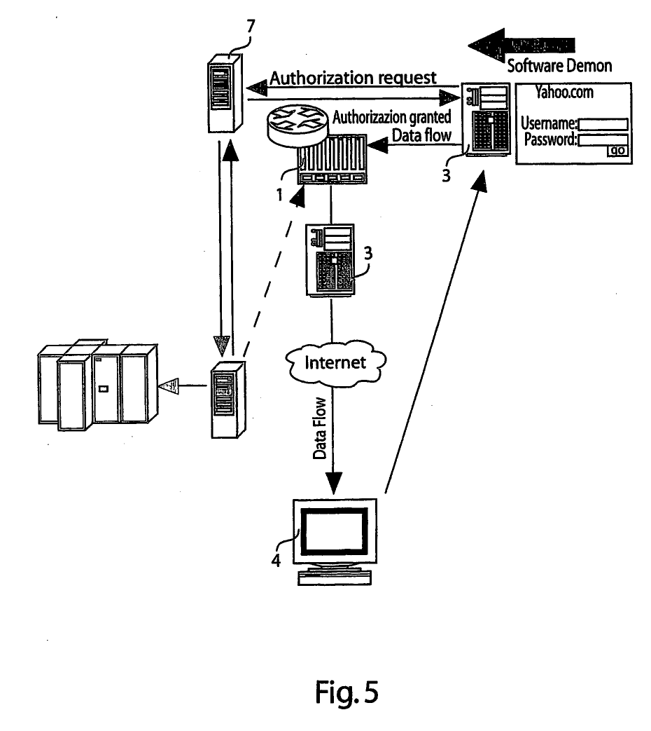

FIG. 5 shows a schematic diagram of a fourth embodiment of the method according to the invention; and

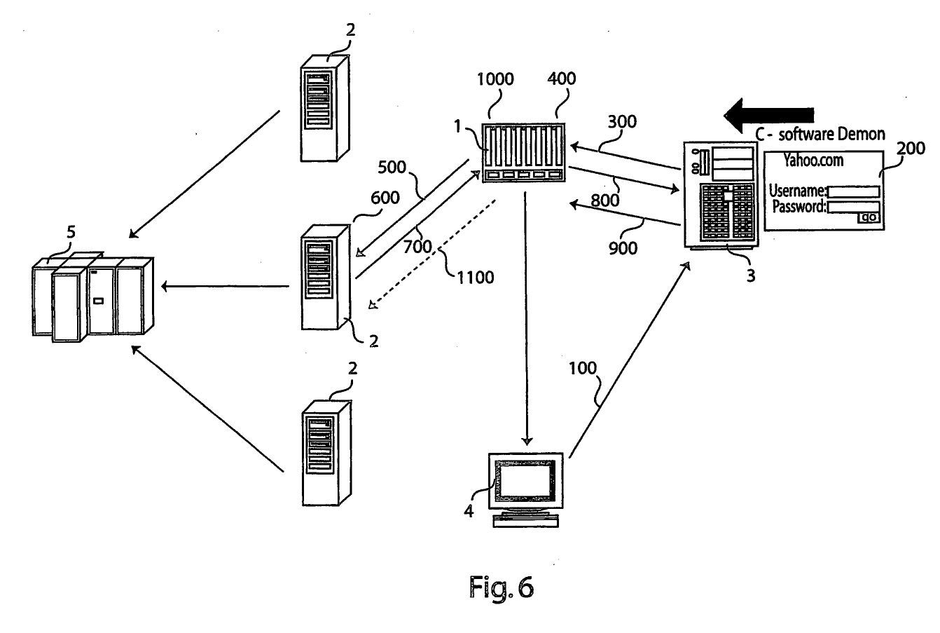

FIG. 6 shows a flow diagram including the steps and the interaction among the various devices and the communication flow according to a preferred embodiment of the method according to the invention.

In the following of the description same references will be used to indicate alike elements in the Figures.

The method according to the invention is based on an inventive conception on electronic transaction, based on the centrality of the information type, causing payment of data packets, preferably embedded in the VAP protocol, which actually are a digital product, rather than the same product (the information content) as a whole.

With reference to FIG. 1, it may be observed that the contents payment system according to the invention is implemented according to a distributed architecture comprising: a routing electronic apparatus or VA router 1, a transaction distributed processing platform or payment gateway 2, and a software or “daemon” operating on server 3 of the Contents Provider.

VA router 1 controls the data flow coming from the Contents Provider (Contents Provider hereinbelow indicated as CP) in a safe manner and it “independently” arranges for taxing the traffic.

Gateway 2 carries out the functions of Identity Provider, i.e. registering of the identities of the users, authentication of the same, managing accounting and invoicing users' uses in relation to the Contents Providers, charging for the various transactions for contents enjoyment of the users, and crediting the Contents Providers accounts. The method and the system according to the invention may be applied to distributed processing platforms, which may belong to different organisations, the system according to the invention being consequently capable to comprise a processing system for the financial compensations among the different platforms according to the principle of the clearing house used in financial environment.

The daemon operating on Contents Provider server 3 conveys data traffic, embedded into the VAP protocol, from Contents Provider server 3 to VA router 1, and it directly interfaces with software of web servers available on the market. In other embodiments of the system according to the invention, the daemon software may separately operate on one or more dedicated servers. The daemon software also include management functionalities, that allows:

a) IP address of the main VAR and of a backup secondary one to be configured; and

b) charging modes, financial remunerations, contents depending on the contents type, time and criteria for access to be determined.

Other embodiments of the method according to the invention, and of the related system, may provide that. at least part of the functionalities of the router 1 and/or gateway 2 are performed by an application software directly installed on user's computer 4, or on CP server 3, or on a gateway of third parties.

The preferred embodiment of the method and of the system according to the invention in FIG. 1 operates according to the following operation modes, similar modes being valid for other embodiments.

By means of his/her own computer 4 and through the use of a standard browser, the user accesses server 3 of his/her Contents Provider operating on the Internet network, requiring accessing chargeable information, preferably by inputting a pair of access enabling identifiers, according to the traditional scheme of a pair of access keys (user name and password). CP server 3 arranges for forwarding the authentication request to gateway 2, possibly belonging to an organisation independent from the CP. Alternatively, such authentication request may be managed by the router 1 operating as intermediary or escrow between server 3 and gateway 2 and the user's computer 4.

Previously, the user has arranged to activate his/her own account with gateway 2 (or, alternatively, with a second gateway, belonging to another Contents Payment Provider, different from gateway 2 and connected thereto) through a payment mode that may be of a prepaid type, or a deductible credit or monthly/yearly charges to be paid later. The payment of the amount may be done by means of credit card, or through other on line payment system, or electronic money, or in a traditional manner (for example, bank payments).

Once gateway 2 has verified the authenticity of the user, gateway 2 communicates to CP server 3 the authorisation to deliver the chargeable contents. The communication of the authorisation may be preferably forwarded by VA router 1 to gateway 2 and from this to server 3. At this point, the user may use all the Contents he/she wants and these will be charged to the user's account according to modes set in advance by the CP, as for example as a function of the spent time, and/or as a function of the importance of delivered information, and/or as a function of the performed single operations (such as searches, or data analysis), and/or as a function of other tariff computation modes, on the basis of the peculiarity of the offered contents. Before accessing the chargeable area, the user is advised of the charging modes in order to give a transparent service enjoyment. Alternatively, costs and charging modes are displayed through the interface of the site or remote resource, or they are displayed in the content link, even by means of explanatory dynamic labels.

The charging process involves VA router 1 after authentication, since the contents are not directly forwarded by server 3 to the user's computer 4, but rather data flow (preferably encoded according to a suitable application protocol, still more preferably the VAP protocol) passes through the router 1, which arranges for sending, to the user's gateway 2, data useful to tariff computation and other information useful to functions of tariff computation and user's account management. In other words, VA router 1 arranges, on the one hand, for taxing or valuing data packets according to the pre-determined charging modes, by carrying out a XML parsing or interpreting the VAP protocol, communicating the charge information to gateway 2, and, on the other hand, for sending the contents to the user. Such mechanism is transparent to the user, who enjoys the contents in a complete manner. Depending on the safety policy that is desired to reach, the connection from CP server 3 to VA router 1, to gateway 2 and then to the user's computer 4 will be clear or encrypted according to an encryption protocol such as SSL (Secure Socket Layer), or another safe transmission protocol.

Gateway 2 progressively receives information of the uses made by the user from VA router 1 and it arranges for recording them in its own memory and for charging the account of the same user for them, by conventionally operating as a user's electronic wallet.

Alternatively, VA router 1 may send information related to carried out uses to a pre-paid, either software or hardware, electronic wallet, that is directly installed on the user's computer 4, which progressively deduct the charged costs.

Depending on the architecture and on the commercial distribution of the contents payment service, gateway 2 directly arranges for crediting the amount owing to the CP for the delivered contents, or for transmitting them to the second gateway, different from gateway 2, with which the CP has activated its own account.

The situation appearing in the latter case is illustrated in FIGS. 2 and 3, showing a second embodiment of the system according to the invention. In particular, the second gateway 5, generally belonging to an organisation different from that of the CP, has the role of crediting and afterwards paying the various CPs adhering to the service for the amounts which various gateways 2, connected to it, have recorded on the basis of the use of users linking to CP server 3 by means of their own computer 4. As already said, in such case the system substantially operates according to the mechanism of a clearing house used in bank environment.

Charging is based on a series of tariff rules set by the Contents provider, which assigns a certain value (price) to each packet as a function of the type of contents and its functional value. The output packets from Contents Provider server 3, on which the daemon software embedding the packets in the VAP protocol has been installed, go towards the user's computer 4 and are taxed through the router 1, which, once the value of each packet in transit is read, charges the related cost to the user's account through gateway 2 and the second gateway 5. By means of a mechanism similar to the clearing house, the several gateways 2 arrange for paying the cost, after deduction of service fee, to the Contents Provider that has supplied the contents. In this way, through a sole system and a sole financial relationship, and with a sole authentication step through a sole digital identity (usemame/password pair or other authentication system), a user may use any chargeable content on the network, by most of paying only the effective use of the content.

In other words, the information reaching the user through data packets (as for example packets of protocol TCP/IP), first pass through VA router 1, that arranges “taxation” of data packets. Preferably, VA router 1 may accept safe connections by means of an encryption system (for example of SSL type) capable to ensure communications safety, in particular between server 3 and gateway 2 and/or the user's computer 4.

In the preferred embodiment of the invention, the VAP protocol uses XML (eXtensible Markup Language) language, which is a language of the SGML (Standard Generalized Markup Language) family. As known, XML language is descriptive more of the document content than of its presentation, differently from HTML, and allows the VAP protocol to be easily implemented by integrating in a file (if the contents use languages of the SGML family) tags including additional information useful for charging functions, as previously indicated. In other cases, such as streaming or continuous sessions, binary code, the XML file may be enclosed with the file as SOAP message, or periodically sent to VA router 1 by the daemon software of server 3. As known, SOAP (Simple Object Access Protocol) is a light protocol for exchanging information in a decentralised and distributed environment. In particular, SOAP may be also employed in normal HTML pages.

Advantageously, the router 1 is also capable to present information in a format displayable by the browser (or other hardware device) of the users computer 4, and to give information on the meaning of transmitted information. In this regard, it is possible to allow the user to be informed on costs and status of transaction through a java applet reading and displaying a message identical to that read by VA router 1. Such implementation may be carried out also on the interface of the web page of a Contents Provider adopting such technology, or as plug-in of the browser or implemented within this.

In such case, the Contents Provider may use the XML language in editing its own contents and it may integrate them with suitable labels or tags having the additional information necessary to the router 1 for applying the charging criteria, such as information cost, and/or tariff computation mode, and/or information title, and/or information type (data, text, audio, video, etc.), and/or the editor, and/or other information useful for charging and accounting activities.

The indicated contents may be enjoyed through a static use, i.e. file to be wholly downloaded before use, and/or through a use of so-called continuous or streaming type, permitting use of audio, video, text, chat, multimedia files (e.g. in videoconference for e-learning and/or consulting service), Voip (Voice Over Ip), query and search services, and software in modes of subscription or pay per use. Moreover, the system may also apply tariff to electronic mailing in a both static and streaming way, for example in a system of mailing list and/or for e-mails in which there are chargeable contents.

Consequently, the method according to the invention permits charging costs on the basis of information included within pages (at the beginning or at the end or at session start or periodically sent during session) which are preferably encoded by means of XML language (or other language of higher level). The system may further use XML via SOAP (Simple Object Access Protocol) message, that is a light protocol for exchanging information in a decentralised and distributed environment. Owing to the implementation of a parser or interpreter of such languages, VA router 1 is capable to read cost information, to be later used for accounting operations.

VA router 1 interprets data in the XML format or in the VAP protocol and so arranges for transmitting data of the current session (i.e. user, charging information, and details of the required information) to gateway 2, so that the latter arranges for charging to the account of the user, previously authenticated, and for crediting to the provider account, through either direct settlement or a clearing house.

More specifically, VA router 1 has the function of analysing the data flow encoded according to the VAP protocol (data being digital Contents and charging information) coming from Contents Provider server 3 and addressed to the user's computer 4. Such data include a series of codes which are interpreted by the router 1 so that this may determine the amount of cost of the Contents delivered to the user when these are little by little transmitted over a telematic network.

As said, the method according to the invention uses a set of rules, which in the implementation of the invention may take the shape of an application communications protocol, within a distributed platform, and belonging to different juridical persons, in order to provide the service of contents payment according to the present invention. Another implementation of such rules may be carried out by means of XML, the page mark-up language that, instead of providing information useful for formatting and presenting a document, provide information on the representation of data and their meaning, so as to be then interpreted and used in an application capable to use these data.

By way of example and not by way of limitation, a series of rules may comprise:

file type (e.g.: text, audio, video, etc., according to MIME encoding);

charging mode (e.g.: start, end, while or streaming);

tariff units (e.g.: packets, document, flat rate);

tariff unit cost, with indication of the currency;

tariff unit interval for charging;

user's identification code (e.g.: username);

Contents provider identification Code;

content Title or identifier.

In such way, the method according to the invention provides additional information for an electronic document or file (which may be a text, or a HTML page, or an audio/video file, or a applet software or a application software, query and search services) that is transmitted over a data communications network. The provided information are related to financial-commercial aspects which certain files may have, in a model of chargeable distribution of contents and information over a telematic network as the Internet.

This series of information are directly encoded in the digital Content, or included through XML, in case of a document of the SGML family, or embedded in a XML file in case of binary file, as an executable or audio file.

Such information may be encoded during editing of the content, preferably by means of suitable software tools simplifying the addition thereof, which are a function that may be included in the daemon software operating on the Contents Provider Web Server 3. Most of all, the daemon software arranges (besides for forwarding the VAP data flow to VA router 1) also for embedding and marking the information into each output packet or file, according to a commercial policy set by the Contents Provider. Such embedding operation may be carried out either directly on the content in advance, through one of the described modes, or instantaneously at content delivery.

Once they are embedded within the Content, such additional information forming the VAP protocol are then read and interpreted by VA router 1 for operations of charging and accounting the contents enjoyed by the user of the CP. Advantageously, the invention makes chargeable navigation not much dissimilar from the free one, since the user is not compelled to carry out a transaction every time he/she requires a certain resource, but transactions continuously occur in a transparent, certain, and visible to user manner, when the user little by little uses site resources. Alternatively, depending on the Content Provider policy, it is possible to apply tariffs as a function of time, such as hours, days, months, besides minutes. In this case VA router 1 or gateway 2 keep transaction in memory as active until such time unit is not expired. The user, who has paid the content having a time validity, each time he will access said resource, through the authentication carried out by VA router 1 along with gateway 2, will not be subject to any charge, up to the content or resource expiry date.

The daemon software operating on server 3, that acts in a manner transparent to the user, addresses the requests of the user's computer 4, sent to Contents Provider server 3, to VA router 1, in order to allow data packets to be forwarded from the information provider server 3 to the router 1 that forwards the data to the user's computer 4. Advantageously, the daemon software is programmed with the IP address of VA router 1, and of other backup ones, in order to locate it over the network. The VA routers may belong to different organisations, which may be Internet Service Provider, financial institutions, mobile and wired telecommunications carrier. Advantageously, within the scope of the present invention, the user and the Contents Provider may have an account in two or more different organisations.

Also, such daemon software may preliminary arrange for forwarding the user's authentication request establishing the connection with gateway 2, in order to permit accessing information on Contents Provider server 3. Alternatively, such authentication request may be managed by the router 1 operating as intermediary between server 3 and gateway 2.

FIGS. 4a and 4b show a schematic flow diagram of the steps of access and contents enjoyment of a user in the preferred embodiment of the method according to the invention, that is the one in which the VAP protocol uses XML and SOAP languages. Differently, other languages and systems may be used for encoding and transmitting the VAP protocol.

In particular, it may be observed that in the first step 10 the user accesses the Contents Provider, and in the following step 11 he/she accesses the chargeable area.

In step 12, the user inputs his/her personal identfication data into server 3 (e.g.: username and password), which are encrypted and sent to VA router 1 (the IP address of which is pre-configured in the daemon software of server 3).

In step 13, through its own gateway search system, router 1 locates the gateway 2 corresponding to the user's identification data and forwards, in following step 14, the access codes (preferably in the shape of username/password where username is of the type username@psp1.com where psp1.com is the domain name of the organisation) to the so-located gateway 2, belonging to the organisation with which the user has an account and is registered.

In step 15, gateway 2 (directly or by sending data to a second gateway 5 of clearing house) checks the user and credit availability.

B assuming a positive outcome of the check, in the following step 16 gateway 2 transmits the authorisation to router 1, that in turn forwards it, in step 17, to CP server 3. Obviously, in case of negative outcome of the check, the authorisation is denied and no contents sending from CP server 3 to user's computer 4 will occur.

In step 18, server 3 starts “data” session, successive to “authentication” session so far described, i.e. transfer by means of the daemon software that forwards the required contents to VA router 1 by encoding them in the VAP protocol, in the case when they have not yet been encoded during editing of contents, as a function of the charging rules and of the Contents Provider policy.

In step 19, router 1 performs parsing of XML header, or interprets VAP protocol if encoded in another language, and, in step 20, it locally stores charging additional information in a memory 6 and/or it transmits them to gateway 2 for operations of charging the user and of crediting the CP. Information transmitted from VA router to gateway 2, in the version herewith presented, may be the same SOAP message, sent from daemon software 3 to VA router 1.

In step 21, contents normally travel over the network as clear ones or encoded in SSL towards the user's computer 4 that receives them in step 22.

In step 23, a software present on the user's computer 4 displays charges and service information through a java applet or a software client or directly on the browser interface or otherwise it receives and reads the SOAP message, comprising VAP protocol header, exchanged by the platform.

In order to optimise financial transactions and reduce their number during work session, router 1 may advantageously store all the operations (for consumption counting purpose) in the local memory 6 and, periodically (e.g.: at the end of the day, preferably during the night for avoiding network traffic problem) it carries out a sole reporting transaction with gateway 2 or directly with a second gateway 5 for payment.

Moreover, router 1 may be also used only for the authentication step within a sign-one system. A sign-one system allows registering once oneself identity and using it on several web sites which interface such sign-one system. In this way, the user has not to register and keep several digital identities for each one of the web sites which he/she uses and which require a registration. In the present invention, organisations managing the infrastructure according to the present invention (gateway 2 and/or router 1) carry out the role of Identity Provider, managing user's identity. Such user's identity may be used in any web site on which the daemon software operates. Through a system of its own ones, router 1 carries out the search of the Identity Provider among all the existing ones, with which the user has been previously registered, by using the domain of the user's usemame, corresponding to the domain name of the Identity Provider. FIG. 5 shows a sign-one system using an external sign-one system. The user requires a protected resource, in a reserved or chargeable area, to CP web server 3 and he/she decides to use his/her own Sign One account. Hence, by linking to the Sign One server 7, the user accesses it and this one checks the status of his/her account on gateway 2. Once it has carried out the necessary controls, this grants the authorisation to Sign One server 7, that in turn grants to the user access to the protected area.

FIG. 6 shows a flow diagram including steps and interaction among the several devices and communication flow. The diagram is similar to that of FIGS. 4a and 4b, where it is represented in the shape of a flow diagram.

In the first step 100, the user 4 accesses the Contents Provider 3 and requires access to a protected or chargeable area, in the following step 200 he/she accesses the chargeable or protected or reserved area. The daemon software is installed on the web server 3.

In step 300, the user inputs his/her own personal identification data into server 3 (for example username and password), which are encrypted and sent to VA router 1 (the IP address of which is pre-configured in the daemon software of server 3). Preferably, data are not stored nor are visible on server 3, rather they are directly sent to router 1.

In step 400, through its own gateway search system, router 1 locates gateway 2 corresponding to user's identification data and, in the following step 500, it forwards the access codes (in the shape of username/password where username is of the type username@psp1.com where psp1.com is the domain name of the organisation implementing the contents payment service according to the present invention) to the so-located gateway 2, belonging to the organisation with which the user has an account and is registered. Router 1 locates gateway 2 of the user starting from the domain name of the user's username, by conducting a query on a DNS system.

In step 600, gateway 2 (directly or by sending the data to a second gateway 5 of clearing house or by accessing another gateway 2) checks the user and the credit availability.

In the case when such check gives a positive outcome, in the following step 700 gateway 2 transmits the authorisation to router 1, that in turn forwards it to CP server 3 in step 800. Obviously, in case of negative outcome of the check, the authorisation is denied and no sending of contents from CP server 3 to the user's computer 4 will occur.

In step 900, server 3 starts “data” session, successive to “authentication” session so far described, i.e. transfer by means of the daemon software that forwards the required contents to router 1 by encoding them in the VAP protocol, in the case when they have not yet been encoded during editing of contents, as a function of the charging rules and of the Contents Provider policy.

In step 1000, router 1 carries out reading and interpretation of the additional information, or it interprets the protocol including the additional information, and it transmits them in step 1100 to gateway 2 for operations of charging the user and crediting the CP, periodically or when necessary.

In step 1200, contents normally travel over the network as clear ones or encoded in SSL towards the user's computer 4 that receives and uses them. Preferably a software, present in the user's computer 4, displays charges and service information by means of a java applet or a software client or directly on the browser interface, which charges and service information are transmitted by the router 1 along with the contents.

VA router 1 comprises the following functionalities: HTTP server and CLI (Command Line Interface) interface for administration functions, as any IP router; system for functions of searching user's gateway 2; XML parser or VAP protocol interpreter when different from XML/SOAP, for reading and interpreting the additional information related to charging; control/diagnostics software; Database Server for keeping connection data; SSL and/or PKI cryptography Management; basic IP routing functions.

Router 1 and gateway 2 may be managed by an Internet Service Provider or by a Contents Payment Provider organisation.

It is evident that the system is proposed as a platform providing different financial persons—among them juridically independent—with interoperability so as to minutely diffuse as a unique standard for payment of effectively enjoyed contents, and at the same time, by distributing databases among several bodies, to ensure users' privacy, avoiding the risk of a centralisation of sensitive data, related to transactions and used chargeable contents, in only one body.

In the method and in the system according to the invention, steps of payment, delivery of the content, and its transmission are integrated and contextual, owing to router 1, since financial valuing of contents enjoyment occurs during the same step of contents delivery. In other words, the financial transaction for charging the enjoyed contents occurs on the same contents enjoyment (through download and transfer of data composing the content), by means of VA router 1 that charges the user and at the same time credits the Contents Provider with the related amounts, when such contents are little by little transferred from Contents Provider server 3 to the user's computer 4, in a valuing mechanism based on the number of IP packets and/or packets embedded into the VAP protocol which are transferred, and/or on time andlor on a flat rate as a function of the content type.

The method according to the invention, and the related system, offer great potentialities to telecommunications network operators, Internet Service Providers, financial institutions and electronic payment systems, completely revolutionising the way of gaining profit from the network for all the Contents providers. Such operators provide Contents providers with such service according to the present invention (allowing them to integrate such invention on their own systems, and final users of contents to pay chargeable contents according to the present system. At the same time, the user may have the possibility to use—and pay—such contents on the basis of the effective use, and with a sole account and a sole authentication process, valid for all the sites adopting the method according to the invention.

The method according to the invention is proposed as a revolutionary technology capable to facilitate payment of contents enjoyable on the, such as text, images, audio, video, multimedia file, or software, query to database and searches on search engines, in a simple and immediate manner, owing to a sole authentication system valid for all the sites and owing to the functionality of charging simultaneous to contents transfer and/or to reception and/or to downloading.

By way of example, owing to the method according to the invention, it is possible to use two or more chargeable sites with a sole authentication, just for making the experience of chargeable contents enjoyment similar to free navigation, where the user may simply pass from a resource to another by means of few clicks. In this case, once it has carried out a first authentication on the first server 3, router 1 keeps the user's identity during the session and, in the case when the user accesses a second site (on which the daemon software operates), it automatically authorises the user, communicating to the second server the authorisation for contents charging.

The method according to the invention allows implementing payment models based on the effective “pay per use”, without needing monthly or yearly or single transaction subscriptions, by using electronic payment systems such as credit card or electronic money.

Decentralised architecture of each key function of a transaction over a plurality of devices of the system according to the invention makes the whole system very reliable and sturdy.

The method according to the invention allows privacy to be respected, that is that the role of identity provider is carried out by more bodies, because decentralised and distributed processing allows data of transactions to be distributed among several systems (belonging to different bodies) and they may be orientated towards transaction values rather than towards what has been acquired, further avoiding user's registration on the CP site.

It is evident the great advantage offered by the method according to the invention, that allows charging costs also on the basis of the number of data packets (which may be also equivalent to the TCP/IP protocol IP packets or they may be the packets encoded in the VAP protocol) which have passed from CP server 3 to the user's computer 4, through router 1.

Other advantages offered by the presence of independent (or Stand alone) router 1 are: reliability, safety, independence (charging operation being carried out by a third party such as the Contents Service Provider organisation, which allows performing an escrow service, totally automated for ensuring the payment and the correct contents delivery between the Contents Provider and the user), safety, need for less computation resources, ease of installation on the network of the Internet Service Provider or of the gateway 2.

The method and the system according to the invention implement a pay-per-use system, capable to charge only data effectively transmitted to users and to manage micro-payments.

They further allow contents transmitted by a third party to be measured in a certain, safe, and trusty manner.

The method and the system according to the invention allow using a sole user account (by acting as sign-one system) valid on all the sites adopting the contents payment system according to the present invention.

They further allow users' privacy to be respected by distributing data related to transactions among several operators, and at the same time keeping the characteristics of sign-one system.

The method and the system according to the invention allow an easy interoperability among different bodies managing the contents payment system, so as to favour a fast diffusion of the payment system according to the present invention.

The preferred embodiments have been above described and some modifications of this invention have been suggested, but it should be understood that those skilled in the art can make variations and changes, without so departing from the related scope of protection, as defined by the following claims.

1. Method for charging costs of enjoying contents transmitted over a telecommunications network, preferably the Internet network, wherein chargeable contents, in the shape of one or more digital documents or files, are transmitted from at least one server (3) of a Contents Provider (or CP), which a user accesses by means of a computer (4) connected to said at least one server (3) through the telecommunications network, a gateway system (2, 5, 7) carrying out the checks for authorisation of the user's access to the chargeable contents, an electronic wallet (5) performing operations of charging costs to a user's account, the method being characterised in that it preliminary associates one or more additional information related to file charging criteria with each chargeable file, and in that it comprises the following steps:
A. at each transmission of at least one portion of a chargeable file from said at least one server (3) of the CP to the user's computer (4), reading and interpreting said additional information associated with the file;
B. transmitting to the user's computer (4) said at least one portion of the chargeable file; and
C. transmitting to the electronic wallet (5) data related to charging as a function of said additional information associated with the file.

2. Method according to claim 1, characterised in that the electronic wallet is integrated into the gateway system (5).

3. Method according to claim 1, characterised in that the electronic wallet is integrated into the user's computer (4).

4. Method according to any one of the preceding claims, characterised in that at least one part of steps A, B, and C is performed by a routing electronic apparatus or router (1).

5. Method according to any one of the preceding claims, characterised in that said additional information associated with each chargeable file comprise:
a file type, preferably according to MIME encoding, and/or
a charging mode preferably selected from the group comprising start charge, end charge, and charge during streaming, and/or
a tariff unit, preferably selected from the group comprising packet unit, document unit, flat rate unit, and/or
a tariff unit cost, and/or
a tariff unit interval for charging, and/or
a user's identification code, and/or
a CP identification code, and/or
a file title or identifier.

6. Method according to any one of the preceding claims, characterised in that said at least one chargeable file portion transmitted in step A is included in a data packet.

7. Method according to any one of the preceding claims, characterised in that said additional information associated with each chargeable file are directly encoded in the chargeable file and/or are included in an auxiliary file associated with the chargeable file.

8. Method according to any one of the preceding claims, characterised in that said at least one chargeable file portion and said associated additional information are encoded in a transmission protocol.

9. Method according to any one of the preceding claims, characterised in that step C is performed immediately before start of transmission of step B or immediately after the end of transmission of step B or periodically during transmission of step B.

10. Method according to any one of the preceding claims,. characterised in that it further comprises the following step:
D. at each transmission of at least one chargeable file portion from said at least one CP server (3) to the users computer (4), reading and/or recording data related to charging as a function of said additional information associated with the file.

11. Method according to claim 10, characterised in that step C is periodically performed independently from time periods of transmission of step B.

12. Method according to claim 10 or 11, when depending on claim 4, characterised in that step D is performed by the router (1).

13. Method according to any one of the preceding claims, characterised in that the gateway system (2, 5, 7) comprises a first gateway apparatus (2).

14. Method according to claim 13, characterised in that the gateway system (2, 5, 7) is distributed and comprises at least a second gateway apparatus (5, 7) connected to the first gateway apparatus (2).

15. Method according to claim 14, characterised in that the gateway system (2, 5, 7) operates according to the mechanism of clearing houses used in financial environment.

16. Method according to any one of the preceding claims, characterised in that the gateway system (2, 5, 7) operates as escrow between the server (3) and the user accessing by means of the computer (4).

17. Method according to claim 4 or any one of claims 5-16, when depending on claim 4, characterised in that the router (1) operates as escrow between the server (3) and the user accessing by means of the computer (4).

18. Method according to any one of the preceding claims, characterised in that in step B information related to cost and/or to the status of chargeable file transmission are transmitted to the user's computer (4).

19. Method according to any one of the preceding claims, characterised in that the user is apt to access two or more servers (3) by means of the computer (4) by inputting data registered in the gateway system (2, 5, 7) which define a sole user's digital identity recognised as valid for all said two or more servers (3).

20. Method according to claim 4 or any one of claims 5-19, when depending on claim 4, characterised in that the router (1) reads and interprets a user's digital identity for locating, through a gateway search system using at least one DNS (Domain Name System) function, an IP address of the gateway system (2, 5, 7) corresponding to the user's one, the router (1) forwarding to the gateway sysfem (2, 5, 7) the authentication request and carrying out charging of contents uses enjoyed by the user accessing by means of the computer (4).

21. System for charging costs of enjoying contents transmitted over a telecommunications network, preferably the Internet network, comprising at least one server (3) of a Contents Provider (or CP), apt to transmit chargeable contents, in the shape of one or more digital documents or files, one or more computers (4), by means of which one or more users access said at least one server (3), a gateway system (2, 5, 7), apt to carry out checks of authorisation of user's access to the chargeable contents and operations of charging costs to a user's account, the system being characterised in that it performs the method for charging costs of enjoying contents transmitted over a telecommunications network according to any one of the preceding claims 1-20.

22. System according to claim 21, characterised in that said at least one server (3) is provided with a plug-in or daemon software, interfacing the http server program that associates said additional information related to file charging criteria with each chargeable file.

23. System according to claim 21 or 22, characterised in that said at least one server (3) performs steps A, B, and C of the method for charging costs of enjoying contents transmitted over a telecommunications network according to any one of claims 1-3, or according to any one of claims 5-20, when not depending on claim 4.

24. System according to claim 21 or 22, characterised in that it further comprises a routing electronic apparatus or router (1), comprising a processing unit, one or more memory units, one or more input/output interfaces, apt to connect to said at least one server (3), to the gateway system (2, 5, 7), and to said one or more computers (4), and apt to perform steps A, B, and C of the method for charging costs of enjoying contents transmitted over a telecommunications network according to claim 4 or according to any one of claims 5-20, when depending on claim 4.

25. System according to any one of claims from 21 to 24, characterised in that the gateway system (2, 5, 7) comprises a first gateway apparatus (2).

26. System according to claim 25, characterised in that the gateway system (2, 5, 7) is distributed and comprises at least a second gateway apparatus (5, 7) connected to the first gateway apparatus (2).

27. System according to claim 26, characterised in that the gateway system (2, 5, 7) operates according to the mechanism of clearing houses used in financial environment.

28. Routing electronic apparatus or router (1), comprising a processing unit, one or more memory units, one or more input/output interfaces, characterised in that it is apt to be used in a system for charging costs of enjoying contents transmitted over a telecommunications network according to claim 24 or any one of claims from 25 to 27, when depending on claim 24, wherein the router (1) is apt to connect to said at least one server (3), to the gateway system (2, 5, 7), and to said one or more computers (4), and it is apt to perform steps A, B, and C of the method for charging costs of enjoying contents transmitted over a telecommunications network according to claim 4 or any one of claims 5-20, when depending on claim 4.

29. Electronic document or file, apt to be transmitted by at least one server (3) of a Contents Provider (or CP) in exchange of a payment according to the method for charging costs of enjoying contents transmitted over a telecommunications network according to any one of the preceding claims 1-20, and in that it is provided with said additional information associated with it.

30. Computer program characterised in that it comprises code means adapted to execute, when running on at least one computer, steps A, B, and C of the method for charging costs of enjoying contents transmitted over a telecommunications network according to any one of the preceding claims 1-20.

31. Memory medium, readable by a computer, storing a program, characterised in that the program is the computer program according to claim 30.

32. Computer program characterised in that it comprises code means adapted to execute, when running on a router (1), step A of the method for charging costs of enjoying contents transmitted over a telecommunications network according to any one of the preceding claims 1-20.

33. Memory medium, readable by a computer, storing a program, characterised in that the program is the computer program according to claim 32.

34. Computer program characterised in that it comprises code means adapted to execute, when running on at least one server (3) of a Contents Provider (or CP) apt to transmit one or more chargeable file, the operation of association of one or more additional information related to file charging criteria with each chargeable file.

35. Memory medium, readable by a computer, storing a program, characterised in that the program is the computer program according to claim 34.

36. Computer program characterised in that it comprises code means adapted, when running on at least one computer, to interface to the http server of the server (3) and to re-address the authentication requests of at least one user and the data flow towards the router (1) of which it has stores the IP address.

37. Memory medium, readable by a computer, storing a program, characterised in that the program is the computer program according to claim 36.
